(19) United States
(12) Patent Application Publication
(10) Pub. No.: US 2013/0009994 A1
(43) Pub. Date: Jan. 10, 2013

(54) METHODS AND APPARATUS TO GENERATE VIRTUAL-WORLD ENVIRONMENTS

(76) Inventor: Thomas Casey Hill, Crystal Lake, IL (US)

(21) Appl. No.: 13/634,836

(22) PCT Filed: Mar. 3, 2011
(86) PCT No.: PCT/US11/27016

§ 371 Date: Sep. 13, 2012

(51) Int. Cl. G09G 5/00

(52) U.S. Cl. 345/633

(57) ABSTRACT

Example methods and apparatus to generate virtual-world environments are disclosed. A disclosed example method involves receiving real-world data associated with a real-world environment in which a person is located at a particular time and receiving virtual-reality data representative of a virtual-world environment corresponding to the real-world environment in which the person was located at the particular time. The method also involves displaying the virtual-world environment based on the virtual-reality data and displaying, in connection with the virtual-world environment, a supplemental visualization based on supplemental user-created information. The supplemental user-created information is obtained based on the real-world data.

### FIELD OF THE DISCLOSURE

The present disclosure relates generally to communication devices and, more particularly, to methods and apparatus to generate virtual-world environments.

### BACKGROUND

Virtual-reality worlds are environments in which users can be immersed in a digital world having appearances and structures of three-dimensional, navigateable spaces. Known virtual-reality worlds are often fantasy-based environments in which programs are used to render features that interact, move, and/or change based on user-inputs. Virtual-reality worlds have historically been rendered by stationary and computationally powerful processor systems to provide users with the ability to navigate fictional worlds and interact with objects and/or characters in those fictional worlds.

### BRIEF DESCRIPTION OF THE DRAWINGS

FIG. 1 depicts an example real-world environment having a person carrying an example mobile device located therein.

FIG. 2 depicts an example composite virtual-world environment image generated based on real-world data, virtual-world data, and user-created information.

FIG. 3 depicts a detailed view of the example composite virtual-world environment image of FIG. 2.

FIG. 4 depicts an example apparatus that may be used to generate the example composite image of FIGS. 2 and 3.

FIG. 5 depicts an example block diagram of the mobile device of FIG. 1.

FIGS. 6A and 6B depict an example flow diagram representative of computer readable instructions that may be used to implement the example apparatus of FIG. 4 to generate the example composite virtual-world environment image of FIGS. 2 and 3.

### DETAILED DESCRIPTION

Although the following discloses example methods, apparatus, and articles of manufacture including, among other components, software executed on hardware, it should be noted that such methods, apparatus, and articles of manufacture are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, apparatus, and articles of manufacture, persons having ordinary skill in the art will readily appreciate that the examples provided are not the only way to implement such methods, apparatus, and articles of manufacture.

It will be appreciated that, for simplicity and clarity of illustration, where considered appropriate, reference numerals may be repeated among the figures to indicate corresponding or analogous elements. In addition, numerous specific details are set forth in order to provide a thorough understanding of example embodiments disclosed herein. However, it will be understood by those of ordinary skill in the art that example embodiments disclosed herein may be practiced without these specific details. In other instances, well-known methods, procedures and components have not been described in detail so as not to obscure example embodiments disclosed herein. Also, the description is not to be considered as limiting the scope of example embodiments disclosed herein.

Example methods, apparatus, and articles of manufacture are disclosed herein in connection with mobile devices, which may be any mobile communication device, mobile computing device, or any other element, entity, device, or service capable of communicating wirelessly. Mobile devices, also referred to as terminals, wireless terminals, mobile stations, communication stations, or user equipment (UE), may include mobile smart phones (e.g., BlackBerry® smart phones), wireless personal digital assistants (PDA), tablet/laptop/notebook/netbook computers with wireless adapters, etc.

Example methods, apparatus, and articles of manufacture disclosed herein may be used to generate virtual-world environments. Such example methods, apparatus, and articles of manufacture enable generating composite virtual-world environments based on real-world data, virtual-world data, and user-created information. In this manner, persons may retrieve and view context-based virtual-world environments indicative or descriptive of surrounding areas in real-world environments in which the persons are located. In some examples, the composite virtual-world environments are displayable on a mobile device. In this manner, a user may view a virtual-world rendering of a real-world location in which the user is located and, in the virtual-world rendering, view user-created information about establishments (e.g., businesses) in the surrounding areas and/or other users in the surrounding areas. In some examples, the user may also specify visual modifications to virtual-reality versions of surrounding buildings, structures, entities, and/or other elements. For example, a user may be located in a city and specify to graphically render a virtual-world version of surrounding structures using a particular theme (e.g., a medieval theme), which changes or modifies the virtual-world representations of the surrounding structures in accordance with the particular theme.

Example methods, apparatus, and articles of manufacture disclosed herein may be used to implement user-collaborative virtual-world environments in which ratings, reviews, directions, and/or other information created by individual users or professional companies are available for context-based retrieval when users are navigating through virtual-world environments corresponding to real-world locations for which such users are seeking ratings, reviews, directions, and/or other information. In some examples, example methods, apparatus, and articles of manufacture disclosed herein may additionally or alternatively be used for gaming services in which users play virtual-world games that involve interactions in real-world activities and/or with real-world objects.

In some examples, user-created information displayable in connection with virtual-world renderings include user-created opinion information or statements about surrounding businesses (e.g., restaurants, stores, bars, retail establishments, entertainment establishments, commercial establishments, or any other business entity). For example, user-created information may be a review of service and/or food at a nearby restaurant. In some examples, other user-created information includes personal information created by users in user-profiles or user accounts of social networking websites (e.g., Facebook, Myspace, etc.). For example, user avatars may be generated and displayed in connection with the virtual-world renderings and messages or personal information created by corresponding users at, for example, participating social networking websites, can be retrieved and displayed in connection with (e.g., adjacent to) the user avatars.

Thus, example methods, apparatus, and articles of manufacture disclosed herein enable mobile device users to view user-created context-based information (e.g., user opinions, user statements, etc.) via their mobile devices about businesses or other entities located in areas surrounding current locations of the mobile device users. Example mobile devices disclosed herein display such context-based information in connection with virtual-world renderings representative of real-world environments in which users are currently located. In this manner, the context-based information is displayed in an intuitive manner that enables users to quickly assess surrounding businesses or entities associated with the context-based information. In addition, other user-created information such as personal information is also displayable in the virtual-renderings in an intuitive manner so that users can relatively easily identify other users with which displayed information is associated.

In some examples, distant virtual-world environments may be visited and corresponding user-created context-based information may be viewed without users needing to be located in corresponding real-world environments. For example, a user in New York City may view virtual-world renderings of Chicago without needing to be located in Chicago. Such distant virtual-world visitations may be used to plan trips and/or explore particular areas or attractions of interest and view user-opinions regarding such areas or attractions.

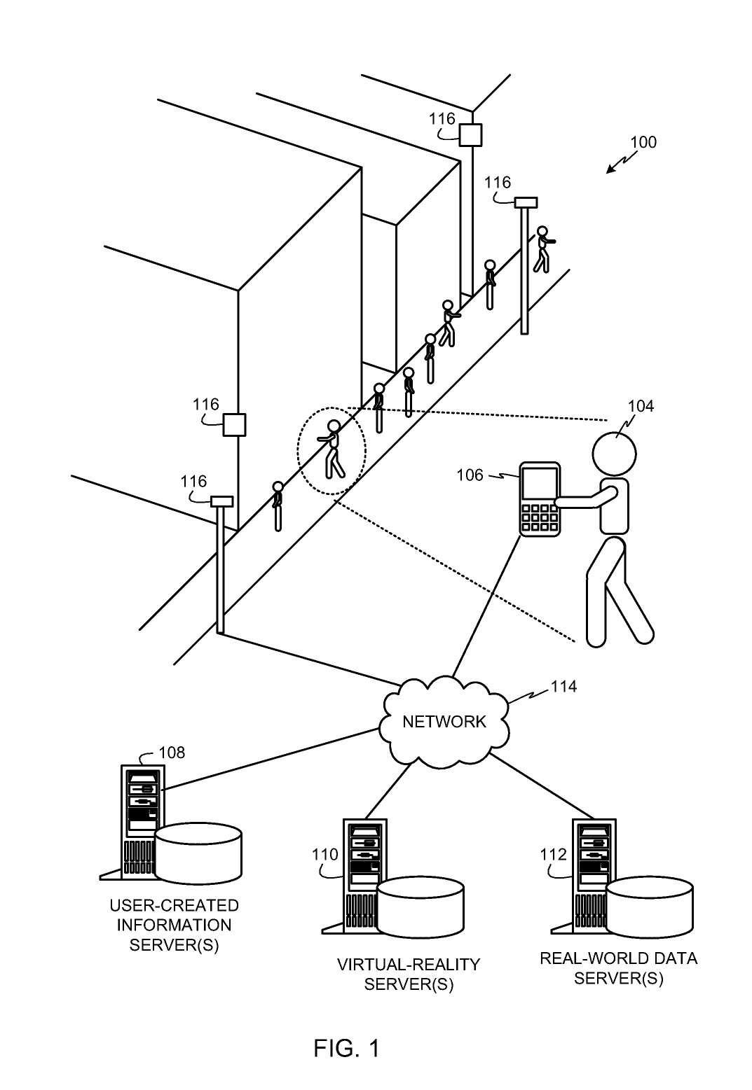

Turning to FIG. 1, an example real-world environment 100 is shown having a person 104 carrying an example mobile device 106 located therein. In the illustrated example, the person 104 uses the mobile device 106 to access a virtual-world rendering of the real-world environment 100 to access information about business, establishments or other entities and/or people located in the real-world environment 100. The mobile device 106 is a wireless mobile smart phone (but may alternatively be implemented using any other type of mobile device), that is in communication with one or more user-created information server(s) 108, one or more virtual-reality server(s) 110, and one or more real-world data server(s) 112. In the illustrated example, the mobile device 106 is in wireless communication with the user-created information server(s) 108, the virtual-reality server(s) 110, and the real-world data server(s) 112 via a network 114.

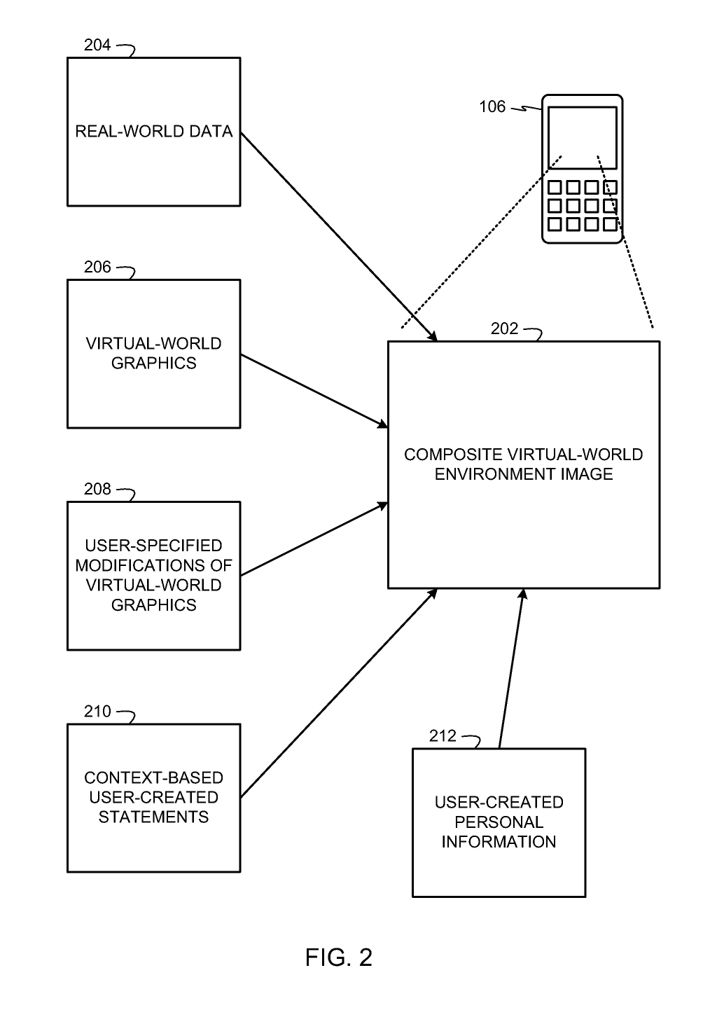

In the illustrated example, the user-created information server(s) 108 store(s) user-created opinions or statements (e.g., context-based user-created statements 210 of FIG. 2) about businesses, establishments, attractions, or other entities, structures, or areas in real-world environments such as the real-world environment 100. For example, the user-created information server 108 may be a social networking server (e.g., a Facebook server, a Myspace server, etc.), a user reviews server (e.g., a Zagat® Survey server), and/or any other user-collaborative repository server (e.g., a wiki server) in which users write or post opinions or statements that are coded with location information or venue names of businesses, establishments, attractions, etc. In this manner, the location or venue name codings can be used to retrieve and display the user-created opinions or statements in association with corresponding locations or venues depicted in virtual-world renderings on the mobile device 106. One or more of the user-created information server(s) 108 (or another user-created information server) of the illustrated example also stores user-created personal information that users typically provide on social networking sites such as names, ages, interests, friend statuses, marital/dating statuses, etc. The user-created personal information can be displayed in association with (e.g., adjacent to) virtual-world avatars that represent real persons (e.g., persons located in the real-world environment 100). For example, if persons located in the real-world environment 100 periodically update their locations (e.g., to store in the user-created information server(s) 108), when the mobile device 106 displays a virtual-world rendering of the real-world environment 100, avatars of those other persons may also be displayed in the virtual-world rendering in association with any corresponding user-created personal information stored in the user-created personal information server 108. In this manner, the person 104 is able to identify other people located in the same real-world area based on those persons' virtual-world avatars displayed on the mobile device 106.

In some examples, user-created information stored in the user-created information server(s) 108 may be temporally-conditional information having definitive expiration times/dates, after which it is no longer valid for displaying. For example, a person (e.g., the person 104) may contribute a user-created statement about the amount of pedestrian traffic in the real-world environment 100 during a current time (e.g., “There are lots of people shopping today.”). Such user-created statement is temporally conditional, because it is only relevant on a current day (i.e., today). After passing of the day on which the user-created statement was posted, the statement is no longer eligible for posting on a virtual-world rendering of the real-world environment 100, because the statement may no longer be relevant or applicable. In some examples, user-created personal information may also be temporally-conditional. For examples, statements such as, “Today is my birthday” or “I'm at the museum—half-price day” have date-specific relevancies and, thus, their eligibility or availability for displaying in virtual-world renderings is temporally-conditional.

The virtual-reality server(s) 110 of the illustrated example store(s) graphical representations (e.g., virtual-reality data 206 of FIG. 2) of real-world environments (e.g., the real-world environment 100) that can be used to generate or render virtual-world environments representative of those real-world environments. The real-world data server 112 of the illustrated example stores information or real-world data (e.g., real-world data 204 of FIG. 2) indicative of environmental characteristics (e.g., weather, pedestrian traffic, automobile traffic, municipal activities, street celebrations, holiday celebrations, etc.) of real-world environments.

In the illustrated example, one or more of the virtual-reality servers 110 also store virtual-world modification data (e.g., user-specified modifications of virtual-world graphics 208 of FIG. 2) useable to modify virtual-world buildings, structures, or other entities representative of real-world structures in a real-world environment. For example, modification data may be organized by themes so that users can view differently themed virtual-world representations of their real-world environments. In some examples, one or more of the virtual-reality servers 110 storing virtual-world modification data may be user-collaborative repository servers (e.g., wiki servers) in which users write or post different theme or modification graphics.

In the illustrated example, stationary sensors 116 are fixedly located throughout the real-world environment 100 to collect real-world data indicative of environmental characteristics (e.g., weather, pedestrian traffic, automobile traffic, municipal activities, street celebrations, holiday celebrations, etc.) surrounding the stationary sensors 116. The stationary sensors 116 of the illustrated example communicate the real-world data via the network 114 to the real-world data server 112 for storing therein. In this manner, virtual-reality worlds generated or rendered based on virtual-reality data stored in the virtual-reality server 110 can be modified or augmented in real-time (or in non-real-time) to appear more temporally relevant based on environmental conditions (e.g., weather, night, day, dusk, dawn, high/low pedestrian traffic, high/low automobile traffic, celebration activity, etc.) detected by the stationary sensors 116.

In some examples, the mobile device 106 is provided with one or more sensors such as location detection subsystems (e.g., global positioning system (GPS) receivers, inertia-based positioning subsystems, etc.), digital compasses, cameras, motion sensors (e.g., accelerometers), etc. to collect real-world data indicative of the locations and/or motions of the mobile device 106 in the real-world environment 100 and/or environmental characteristics surrounding the mobile device 106. In some examples, the sensor data collected by the mobile device 106 is used by the mobile device 106 to navigate through virtual-world environments rendered by the mobile device 106. For example, if the person 104 desires to investigate restaurants or entertainment venues in nearby areas, the person 104 may request the mobile device 106 to generate a virtual-world environment of the person's current location. In response, a GPS receiver of the mobile device 106 may provide location information so that the mobile device 106 can retrieve location-specific virtual-world graphics from the virtual-reality server 110 and render a virtual-world environment representative of the location at which the person 104 is located. A digital compass of the mobile device 106 may be used to provide facing or viewing directions so that as the person 104 faces different directions, the virtual-world environment rendered on the mobile device 106 also changes perspective to be representative of the viewing direction of the person 104. As the person 104 walks through the real-world environment, the GPS receiver and the digital compass can continually provide real-world data updates (e.g., updates on real-world navigation and movement) so that the mobile device 106 can update virtual-world environment renderings to correspond with the real-world movements and locations of the person 104.

Turning to FIG. 2, an example composite virtual-world environment image 202 is generated based on real-world data 204, virtual-reality data 206, user-specified modifications of virtual-world graphics 208, context-based user-created statements 210, and user-created personal information 212. In the illustrated example, the composite virtual-world environment image 202 is a virtual-world environment that can be generated by an application on the mobile device 106 or at a network entity (e.g., the virtual-reality server 110 of FIG. 1) that is in communication with the mobile device 106. The composite virtual-world environment image 202 of the illustrated example is rendered on the mobile device 106 of FIG. 1. In some examples, the composite virtual-world environment image 202 is generated by an application executed on the mobile device 106, while in other examples, the composite virtual-world environment image 202 is generated at a network location (e.g., at the virtual-reality server 110) and communicated to the mobile device 106 for displaying.

In the illustrated example of FIG. 2, to render the composite virtual-world environment image 202, the mobile device 106 (or a network entity in communication with the mobile device 106) retrieves the real-world data 204 to determine a location for which the mobile device 106 is requesting to display a virtual-world environment. In the illustrated example, the real-world data 204 can be collected using sensors of the mobile device 106, in which case some or all of the real-world data 204 is obtained from the mobile device 106. Additionally or alternatively, the real-world data 204 may be collected using the stationary sensors 116 of FIG. 1, in which case some or all of the real-world data 204 can be retrieved from the real-world data server 112 of FIG. 1. In the illustrated example, the mobile device 106 uses the real-world data 204 to determine context information such as a person's location and/or a person's direction of viewing and retrieves the virtual-reality data 206 corresponding to the context information from, for example, the virtual-reality server 110 of FIG. 1. For example, if the mobile device 106 is located in the real-world environment 100 of FIG. 1, the virtual-reality data 206 includes virtual-world graphics, textures, lighting conditions, etc. that are representative of structures, features, characteristics, and/or attractions of the real-world environment 100 in an area surrounding the location of mobile device 106.

In some examples, a user (e.g., the person 104 of FIG. 1) may elect to modify the virtual-world appearance depicted by the virtual-reality data 206. Such modifications can be implemented using the user-specified modifications of virtual-world graphics 208, which may be user-specified themes or any other kind of user-specified modifications of structures, features, characteristics, and/or attractions depicted by the virtual-reality data 206. Under such user-specified modifications, the general layout of a virtual-world represented in the composite virtual-world environment image 202 remains generally intact such that it is still representative of a corresponding real-world environment (e.g., the real-world environment 100 of FIG. 1). However, aesthetic and/or functional features and/or characteristics of depicted structures may be changed or modified to appear different from their corresponding counterparts located in a real-world environment. For example, the person 104 may elect to modify the virtual-reality data 206 to represent a medieval environment, in which case buildings represented in the virtual-reality data 206 may be modified to have turrets, towers, sandstone construction, drawbridges, columns, gargoyles, battlement roof structures, or any other medieval-type features. If the person 104 elects to modify the virtual-reality data 206 to represent a futuristic environment, features and/or characteristics of the virtual-reality data 206 may be modified to have neon lighting, hover-craft vehicles, neon-lighted raceways or tracks as roadways and/or sidewalks, etc.

In some examples, a user (e.g., the person 104 of FIG. 1) may elect to view the context-based user-created statements 210 (e.g., opinions, factual statements, etc.) created or provided by other persons or organizations about businesses, establishments, or other attractions in the area represented by the virtual-reality data 206. In such some examples, the context-based user-created statements 210 are retrievable from the user-created information server(s) 108, and the mobile device 106 can display the context-based user-created statements 210 in the composite virtual-world environment image 202.

In some examples, a user (e.g., the person 104 of FIG. 1) may elect to view the user-created personal information 212 about other persons (e.g., personal information provided by those other persons) represented by avatars depicted in the composite virtual-world environment image 202. In such some examples, the user-created personal information 212 can be obtained from the user-created information server(s) 108 of FIG. 1.

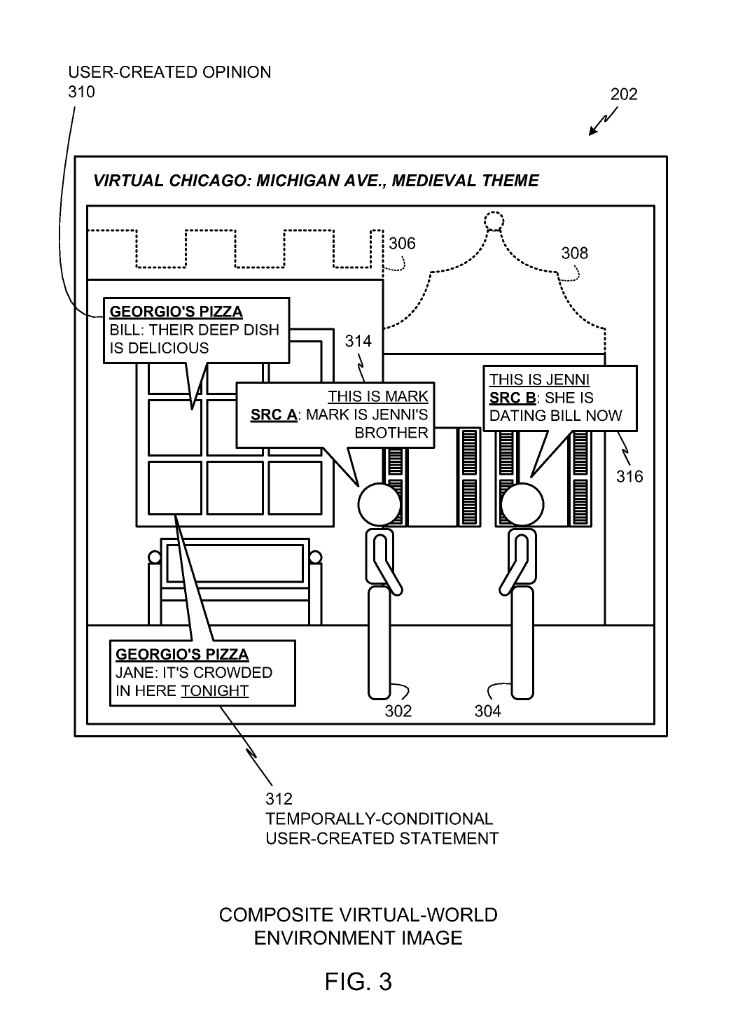

FIG. 3 depicts a detailed view of the example composite virtual-world environment image 202 of FIG. 2. In the illustrated example, the composite virtual-world environment image 202 is representative of a location on Michigan Ave. in Chicago, Ill., United States of America (e.g., the real-world environment 100 of FIG. 1). In addition, virtual-world graphics of the composite virtual-world environment image 202 of the illustrated example are modified using a medieval theme. In the illustrated example, the composite virtual-world environment image 202 is displayed on the mobile device 106 from a point of view or perspective of the person 104 holding the mobile device 106. Thus, in the real-world environment 100 of FIG. 1 (e.g., which is represented in the composite virtual-world environment image 202), the person 104 is facing two people, represented by avatars 302 and 304, in front of two adjacent buildings. In the illustrated example, the people represented by the avatars 302 and 304 are registered users of one or more services that contribute information to enable the composite virtual-world environment image 202 and that enable(s) people to periodically update their locations in the real world (e.g., in the real-world environment 100). Thus, during generation of the composite virtual-world environment image 202, one or more of the virtual-reality server(s) 110 (FIG. 1) provide(s) the avatars 302 and 304 corresponding to the respective registered users to represent that the registered users are standing in the real-world at the location represented by the composite virtual-world environment image 202 in the virtual world.

In the illustrated example of FIG. 3, the user-specified modifications of virtual-world graphics 208 (FIG. 2) provide medieval theme modifications of surrounding structures depicted in the composite virtual-world environment image 202. In FIG. 3, the medieval theme modifications are shown in the form of a battlement roof structure 306 and a turret roof structure 308 that are added to building structures that otherwise represent buildings present at the depicted location in the real world (e.g., in the real-world environment 100 of FIG. 1). In some examples, user-specified modifications may also include modifications to avatars (e.g., the avatars 302 and 304). For example, a medieval theme may cause avatars to appear dressed in medieval attire and/or armor and, in some instances, may altar body structures of the avatars.

In the illustrated example of FIG. 3, the composite virtual-world environment image 202 includes supplemental visualizations based on supplemental user-created information. Example supplemental visualizations are shown in FIG. 3 as a user-created opinion 310 (e.g., obtained from the context-based user-created statements 210 of FIG. 2), a temporally-conditional user-created statement 312 (e.g., obtained from the context-based user-created statements 210 of FIG. 2), and user-created personal information 314 and 316 (e.g., obtained from the user-created personal information 212).

The user-created opinion 310 of the illustrated example is shown in the context of a pizza shop located in the area depicted by the composite virtual-world environment image 202. In the illustrated example, the user-created opinion 310 was created by a user having a username ‘Bill’ and states “Their deep dish is delicious” about a restaurant venue named Georgio's Pizza.

The temporally-conditional user-created statement 312 of the illustrated example is also shown in the context of Georgio's Pizza shop and states, “It's crowded in here tonight.” In the illustrated example, the temporally-conditional user-created statement 312 is relevant only to the date on which it was created by a user, because the statement refers to a particular night (i.e., tonight). Thus, the temporally-conditional user-created statement 312 is displayed on the composite virtual-world environment image 202 because it was posted on the same date on which the composite virtual-world environment image 202 was generated and, thus, the temporally-conditional user-created statement 312 is temporally relevant. However, the temporally-conditional user-created statement 312 of the illustrated example is not relevant for displaying on a composite virtual-world environment image a day after the statement 312 was created.

The user-created opinion 310 and the temporally-conditional user-created statement 312 of the illustrated example are stored in one or more of the user-created information servers 108 of FIG. 1 in association with location information or address information corresponding to where Georgio's Pizza is located in the real-world environment 100 of FIG. 1. In this manner, the user-created opinion 310 and the temporally-conditional user-created statement 312 can be retrieved from the user-created information server(s) 108 based on address or location information associated with or near the location at which the person 104 is located when the composite virtual-world environment image 202 is generated.

In the illustrated example, the avatars 302 and 304 are shown with respective ones of the user-created personal information 314 and 316 displayed in association therewith. The user-created personal information 314 of the illustrated example is obtained from a source A (SRC A) server (e.g., one of the user-created information server(s) 108 of FIG. 1). In the illustrated example, the user-created personal information 314 identifies the avatar 302 as representing a user with a username of ‘Mark’ and indicates that “Mark is Jenni's brother.” The user-created personal information 316 of the illustrated example is obtained from a source B (SRC B) server (e.g., one of the user-created information server(s) 108 of FIG. 1). In the illustrated example, the user-created personal information 316 identifies the avatar 304 as representing a user with a username of ‘Jenni’ and indicates that “Jenni is dating Bill now.” Although not shown in FIG. 3, some user-created personal information may be temporally-conditional such that it is relevant for displaying based on current dates and/or times.

The user-created personal information 314 and 316 of the illustrated example are stored in one or more of the user-created information servers 108 of FIG. 1 in association with username or user identifier information corresponding to the registered users represented by the avatars 302 and 304. In this manner, the user-created personal information 314 and 316 can be retrieved from the user-created information server(s) 108 based on usernames or user identifiers of persons detected as being located near the location at which the person 104 is located in the real-world environment 100 when the composite virtual-world environment image 202 is generated.

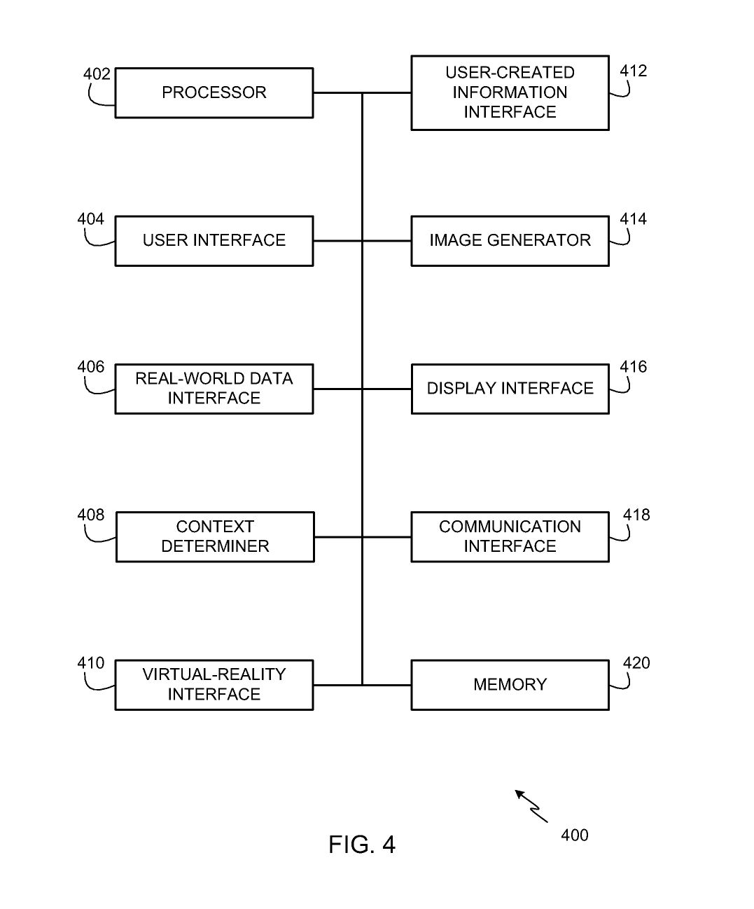

FIG. 4 depicts an example apparatus 400 that may be used to generate the example composite virtual-world environment image 202 of FIGS. 2 and 3. The example apparatus 400 may be implemented using the mobile device 106 (FIGS. 1 and 2) in examples in which the mobile device 106 obtains information, renders the composite virtual-world environment image 202, and displays the composite virtual-world environment image 202. In examples in which the composite virtual-world environment image 202 is rendered by a network entity (e.g., the virtual-reality server 110 of FIG. 1), the example apparatus 400 is implemented by the network entity and is in communication with the mobile device 106. In the illustrated example of FIG. 4, the apparatus 400 is provided with a processor (or controller) 402, a user interface 404, a real-world data interface 406, a context determiner 408, a virtual-reality interface 410, a user-created information interface 412, an image generator 414, a display interface 416, a communication interface 418, and a memory 420. The processor 402, the user interface 404, the real-world data interface 406, the context determiner 408, the virtual-reality interface 410, the user-created information interface 412, the image generator 414, the display interface 416, the communication interface 418, and/or the memory 420 may be implemented using any desired combination of hardware, firmware, and/or software. For example, one or more integrated circuits, discrete semiconductor components, and/or passive electronic components may be used. Thus, for example, processor 402, the user interface 404, the real-world data interface 406, the context determiner 408, the virtual-reality interface 410, the user-created information interface 412, the image generator 414, the display interface 416, the communication interface 418, and/or the memory 420, or parts thereof, could be implemented using one or more circuit(s), programmable processor(s), application specific integrated circuit(s) (ASIC(s)), programmable logic device(s) (PLD(s)), field programmable logic device(s) (FPLD(s)), etc. The processor 402, the user interface 404, the real-world data interface 406, the context determiner 408, the virtual-reality interface 410, the user-created information interface 412, the image generator 414, the display interface 416, the communication interface 418, and/or the memory 420, or parts thereof, may be implemented using instructions, code, and/or other software and/or firmware, etc. stored on a machine accessible medium or computer readable medium (e.g., the memory 420) and executable by, for example, a processor (e.g., the example processor 402). When any of the appended claims are read to cover a purely software implementation, at least one of the processor 402, the user interface 404, the real-world data interface 406, the context determiner 408, the virtual-reality interface 410, the user-created information interface 412, the image generator 414, the display interface 416, the communication interface 418, or the memory 420 is hereby expressly defined to include a tangible medium such as a solid state memory, a magnetic memory, a DVD, a CD, etc.

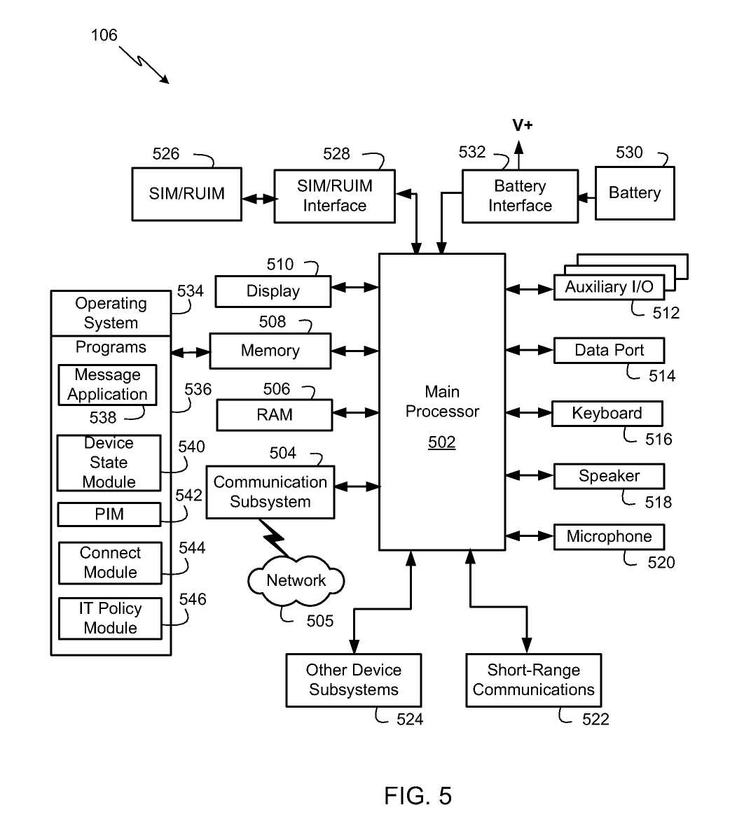

Turning in detail to FIG. 4, the apparatus 400 of the illustrated example is provided with the example processor 402 to control and/or manage operations of the apparatus 400. For example, the processor 402 manages exchanges of information in the apparatus 400 and performs decision making processes. In examples in which the apparatus 400 is implemented using the mobile device 106 of FIGS. 1 and 2, the example processor 402 is implemented by the example processor 502 of FIG. 5 and is configured to control the overall operations of the mobile device 106.

To receive user input, the apparatus 400 of the illustrated example is provided with the example user interface 404. The example user interface 404 may be implemented using button interface(s), key interface(s), a touch panel interface, graphical user input interfaces, or any other type of user interface capable of receiving user input information.

To receive real-world data from sensors (e.g., sensors of the mobile device 106 and/or the stationary sensors 116 of FIG. 1), the apparatus 400 is provided with the real-world data interface 406. In examples in which the real-world data (e.g., sensor data) is from the stationary sensors 116, the real-world data interface 406 retrieves the real-world data from the real-world data server(s) 112 of FIG. 1.

To determine locations and points of views of users (e.g., the person 104 of FIG. 1), the apparatus 400 is provided with the context determiner 408. In the illustrated example, the context determiner 408 determines locations at which the mobile device 106 is located and directions of view or points of views toward which the person 104 is facing. Such location and directions of view information is used by the context determiner 408 to determine contextual information useable by the apparatus 400 to retrieve virtual-world graphics (e.g., the virtual-reality data 206 of FIG. 2) and user-created information (e.g., the context-based user-created statements 210 and the user-created personal information 212 of FIG. 2) that is relevant and/or representative of the locations at which the person 104 is located in the real world (e.g., at locations in the real-world environment 100 of FIG. 1).

To retrieve virtual-world graphics (e.g., the virtual-reality data 206 of FIG. 2), the apparatus 400 is provided with the virtual-reality interface 410. In the illustrated example, the virtual-reality interface 410 retrieves the virtual-reality data 206 and the user-specified modifications of virtual-world graphics 208 of FIG. 2 (e.g., the battlement roof structure 306 and the turret roof structure 308 of FIG. 3) from the virtual-reality server(s) 110 of FIG. 1. The virtual-reality interface 410 of the illustrated example is also configured to retrieve images for the avatars 302 and 304 from, for example, user-created information server(s) 108 and/or the virtual-reality server(s) 110 of FIG. 1.

To retrieve user-created information (e.g., the context-based user-created statements 210 and/or the user-created personal information 212 of FIG. 2), the apparatus 400 is provided with the user-created information interface 412. In the illustrated example, the user-created information interface 412 obtains user-created information from, for example, the user-created information server(s) 108. The user-created information interface 412 of the illustrated example is also configured to determine relevancy of user-created information based on context (e.g., location and/or facing direction or point of view) and/or temporal conditions (e.g., current time and/or date information).

To generate the composite virtual-world environment image 202 of FIGS. 2 and 3, the apparatus 400 is provided with the image generator 414. In the illustrated example, the image generator 414 receives the virtual-reality data 206, the user-specified modifications of virtual-world graphics 208, the context-based user-created statements 210, and/or the user-created personal information 212 of FIG. 2 and generates the composite virtual-world environment image 202 by arranging the graphics and information relative to one another as shown in, for example, FIG. 3.

To display the composite virtual-world environment image 202 of FIGS. 2 and 3, the apparatus 400 is provided with the display interface 416. In the illustrated example, the display interface 416 may be in communication with a display (e.g., the display 510 of FIG. 5) of the mobile device 106 to render the composite virtual-world environment image 202 for viewing by the person 104.

To communicate with the network 114 of FIG. 1, the apparatus is provided with the communication interface 418. In the illustrated example, the communication interface 418 is a wireless interface. Example wireless communication technologies that may be employed to implement the one or more communication subsystem(s) 1012 include, for example, cellular wireless technologies, 3G wireless technologies, Global System for Mobile Communications (GSM) wireless technologies, enhanced data rates for GSM evolution (EDGE) wireless technologies, code division multiple access (CDMA) wireless technologies, time division multiple access (TDMA) wireless technologies, IEEE® 802.11 wireless technology, BLUETOOTH® wireless technology, ZIGBEE® wireless technology, wireless USB radio technology, and ultra-wideband (UWB) radio technology. In some examples, the communication interface 418 may alternatively be a wired communication interface.

In the illustrated example, to store data and/or machine-readable or computer-readable instructions, the apparatus 400 is provided with the memory 420. The memory 420 may be a mass storage memory magnetic or optical memory, a non-volatile integrated circuit memory, or a volatile memory. That is, the memory 420 may be any tangible medium such as a solid state memory, a magnetic memory, a DVD, a CD, etc.

FIG. 5 depicts a block diagram of an example implementation of a processor system that may be used to implement the mobile device 106 of FIGS. 1 and 2. In the illustrated example, the mobile device 106 is a two-way communication device with advanced data communication capabilities including the capability to communicate with other wireless-enabled devices or computer systems through a network of transceiver stations. The mobile device 106 may also have the capability to allow voice communication. Depending on the functionality provided by the mobile device 106, it may be referred to as a data messaging device, a two-way pager, a cellular telephone with data messaging capabilities, a smart phone, a wireless Internet appliance, or a data communication device (with or without telephony capabilities). To aid the reader in understanding the structure of the mobile device 106 and how it communicates with other devices and host systems, FIG. 5 will now be described in detail.

Referring to FIG. 5, the mobile device 106 includes a number of components such as a main processor 502 that controls the overall operation of the mobile device 106. Communication functions, including data and voice communications, are performed through a communication subsystem 504. The communication subsystem 504 receives messages from and sends messages to a wireless network 505. In the illustrated example of the mobile device 106, the communication subsystem 504 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the example implementations described herein are intended to use any other suitable standards that are developed in the future. The wireless link connecting the communication subsystem 504 with the wireless network 505 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 505 associated with the mobile device 106 is a GSM/GPRS wireless network in one exemplary implementation, other wireless networks may also be associated with the mobile device 106 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include WiFi 802.11, MOBITEX® and DATATAC® network communication systems. Examples of other voice-centric data networks include Personal Communication Systems (PCS) networks like GSM and Time Division Multiple Access (TDMA) systems.

The main processor 502 also interacts with additional subsystems such as a Random Access Memory (RAM) 506, a persistent memory 508 (e.g., a non-volatile memory), a display 510, an auxiliary input/output (I/O) subsystem 512, a data port 514, a keyboard 516, a speaker 518, a microphone 520, a short-range communication subsystem 522, and other device subsystems 524.

Some of the subsystems of the mobile device 106 perform communication-related functions, whereas other subsystems may provide “resident” or on-device functions. By way of example, the display 510 and the keyboard 516 may be used for both communication-related functions, such as entering a text message for transmission over the network 505, and device-resident functions such as a calculator or task list.

The mobile device 106 can send and receive communication signals over the wireless network 505 after required network registration or activation procedures have been completed. Network access is associated with a subscriber or user of the mobile device 106. To identify a subscriber, the mobile device 106 requires a SIM/RUIM card 526 (i.e., Subscriber Identity Module or a Removable User Identity Module) to be inserted into a SIM/RUIM interface 528 in order to communicate with a network. The SIM card or RUIM 526 is one type of a conventional “smart card” that can be used to identify a subscriber of the mobile device 106 and to personalize the mobile device 106, among other things. Without the SIM card 526, the mobile device 106 is not fully operational for communication with the wireless network 505. By inserting the SIM card/RUIM 526 into the SIM/RUIM interface 528, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 526 includes a processor and memory for storing information. Once the SIM card/RUIM 526 is inserted into the SIM/RUIM interface 528, it is coupled to the main processor 502. In order to identify the subscriber, the SIM card/RUIM 526 can include some user parameters such as an

International Mobile Subscriber Identity (IMSI). An advantage of using the SIM card/RUIM 526 is that a subscriber is not necessarily bound by any single physical mobile device. The SIM card/RUIM 526 may store additional subscriber information for a mobile device as well, including datebook (or calendar) information and recent call information. Alternatively, user identification information can also be programmed into the persistent memory 508.

The mobile device 106 is a battery-powered device and includes a battery interface 532 for receiving one or more rechargeable batteries 530. In at least some embodiments, the battery 530 can be a smart battery with an embedded microprocessor. The battery interface 532 is coupled to a regulator (not shown), which assists the battery 530 in providing power V+ to the mobile device 106. Although current technology makes use of a battery, future technologies such as micro fuel cells may provide the power to the mobile device 106.

The mobile device 106 also includes an operating system 534 and software components 536 to 546 which are described in more detail below. The operating system 534 and the software components 536 to 546 that are executed by the main processor 502 are typically stored in a persistent store such as the persistent memory 508, which may alternatively be a read-only memory (ROM) or similar storage element (not shown). Those skilled in the art will appreciate that portions of the operating system 534 and the software components 536 to 546, such as specific device applications, or parts thereof, may be temporarily loaded into a volatile store such as the RAM 506. Other software components can also be included, as is well known to those skilled in the art.

The subset of software applications 536 that control basic device operations, including data and voice communication applications, will normally be installed on the mobile device 106 during its manufacture. Other software applications include a message application 538 that can be any suitable software program that allows a user of the mobile device 106 to send and receive electronic messages. Various alternatives exist for the message application 538 as is well known to those skilled in the art. Messages that have been sent or received by the user are typically stored in the persistent memory 508 of the mobile device 106 or some other suitable storage element in the mobile device 106. In at least some embodiments, some of the sent and received messages may be stored remotely from the mobile device 106 such as in a data store of an associated host system that the mobile device 106 communicates with.

The software applications can further include a device state module 540, a Personal Information Manager (PIM) 542, and other suitable modules (not shown). The device state module 540 provides persistence (i.e., the device state module 540 ensures that important device data is stored in persistent memory, such as the persistent memory 508, so that the data is not lost when the mobile device 106 is turned off or loses power).

The PIM 542 includes functionality for organizing and managing data items of interest to the user, such as, but not limited to, e-mail, contacts, calendar events, voice mails, appointments, and task items. A PIM application has the ability to send and receive data items via the wireless network 505. PIM data items may be seamlessly integrated, synchronized, and updated via the wireless network 505 with the mobile device subscriber's corresponding data items stored and/or associated with a host computer system. This functionality creates a mirrored host computer on the mobile device 106 with respect to such items. This can be particularly advantageous when the host computer system is the mobile device subscriber's office computer system.

The mobile device 106 also includes a connect module 544, and an IT policy module 546. The connect module 544 implements the communication protocols that are required for the mobile device 106 to communicate with the wireless infrastructure and any host system, such as an enterprise system, that the mobile device 106 is authorized to interface with.

The connect module 544 includes a set of APIs that can be integrated with the mobile device 106 to allow the mobile device 106 to use any number of services associated with the enterprise system. The connect module 544 allows the mobile device 106 to establish an end-to-end secure, authenticated communication pipe with the host system. A subset of applications for which access is provided by the connect module 544 can be used to pass IT policy commands from the host system (e.g., from an IT policy server of a host system) to the mobile device 106. This can be done in a wireless or wired manner. These instructions can then be passed to the IT policy module 546 to modify the configuration of the mobile device 106. Alternatively, in some cases, the IT policy update can also be done over a wired connection.

The IT policy module 546 receives IT policy data that encodes the IT policy. The IT policy module 546 then ensures that the IT policy data is authenticated by the mobile device 106. The IT policy data can then be stored in the flash memory 506 in its native form. After the IT policy data is stored, a global notification can be sent by the IT policy module 546 to all of the applications residing on the mobile device 106. Applications for which the IT policy may be applicable then respond by reading the IT policy data to look for IT policy rules that are applicable.

The IT policy module 546 can include a parser (not shown), which can be used by the applications to read the IT policy rules. In some cases, another module or application can provide the parser. Grouped IT policy rules, described in more detail below, are retrieved as byte streams, which are then sent (recursively, in a sense) into the parser to determine the values of each IT policy rule defined within the grouped IT policy rule. In at least some embodiments, the IT policy module 546 can determine which applications (e.g., applications that generate the virtual-world environments such as the composite virtual-world environment image 202 of FIGS. 2 and 3) are affected by the IT policy data and send a notification to only those applications. In either of these cases, for applications that aren't running at the time of the notification, the applications can call the parser or the IT policy module 546 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 546 sends an acknowledgement back to the host system to indicate that the IT policy data was received and successfully applied.

Other types of software applications can also be installed on the mobile device 106. These software applications can be third party applications, which are added after the manufacture of the mobile device 106. Examples of third party applications include games, calculators, utilities, etc.

The additional applications can be loaded onto the mobile device 106 through at least one of the wireless network 505, the auxiliary I/O subsystem 512, the data port 514, the short-range communications subsystem 522, or any other suitable device subsystem 524. This flexibility in application installation increases the functionality of the mobile device 106 and may provide enhanced on-device functions, communication-related functions, or both. For example, secure communication applications may enable electronic commerce functions and other such financial transactions to be performed using the mobile device 106.

The data port 514 enables a subscriber to set preferences through an external device or software application and extends the capabilities of the mobile device 106 by providing for information or software downloads to the mobile device 106 other than through a wireless communication network. The alternate download path may, for example, be used to load an encryption key onto the mobile device 106 through a direct and thus reliable and trusted connection to provide secure device communication.

The data port 514 can be any suitable port that enables data communication between the mobile device 106 and another computing device. The data port 514 can be a serial or a parallel port. In some instances, the data port 514 can be a USB port that includes data lines for data transfer and a supply line that can provide a charging current to charge the battery 530 of the mobile device 106.

The short-range communications subsystem 522 provides for communication between the mobile device 106 and different systems or devices, without the use of the wireless network 505. For example, the subsystem 522 may include an infrared device and associated circuits and components for short-range communication. Examples of short-range communication standards include standards developed by the Infrared Data Association (IrDA), a Bluetooth® communication standard, and the 802.11 family of standards developed by IEEE.

In use, a received signal such as a text message, an e-mail message, web page download, media content, etc. will be processed by the communication subsystem 504 and input to the main processor 502. The main processor 502 will then process the received signal for output to the display 510 or alternatively to the auxiliary I/O subsystem 512. A subscriber may also compose data items, such as e-mail messages, for example, using the keyboard 516 in conjunction with the display 510 and possibly the auxiliary I/O subsystem 512. The auxiliary subsystem 512 may include devices such as: a touch screen, mouse, track ball, infrared fingerprint detector, or a roller wheel with dynamic button pressing capability. The keyboard 516 is preferably an alphanumeric keyboard and/or telephone-type keypad. However, other types of keyboards may also be used. A composed item may be transmitted over the wireless network 505 through the communication subsystem 504.

For voice communications, the overall operation of the mobile device 106 is substantially similar, except that the received signals are output to the speaker 518, and signals for transmission are generated by the microphone 520. Alternative voice or audio I/O subsystems, such as a voice message recording subsystem, can also be implemented on the mobile device 106. Although voice or audio signal output is accomplished primarily through the speaker 518, the display 510 can also be used to provide additional information such as the identity of a calling party, duration of a voice call, or other voice call related information.

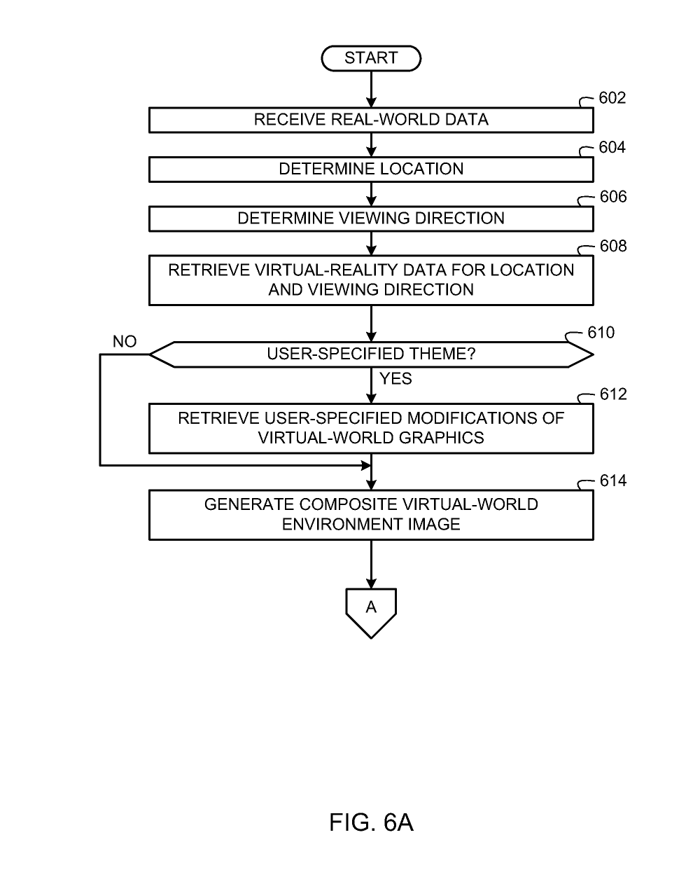

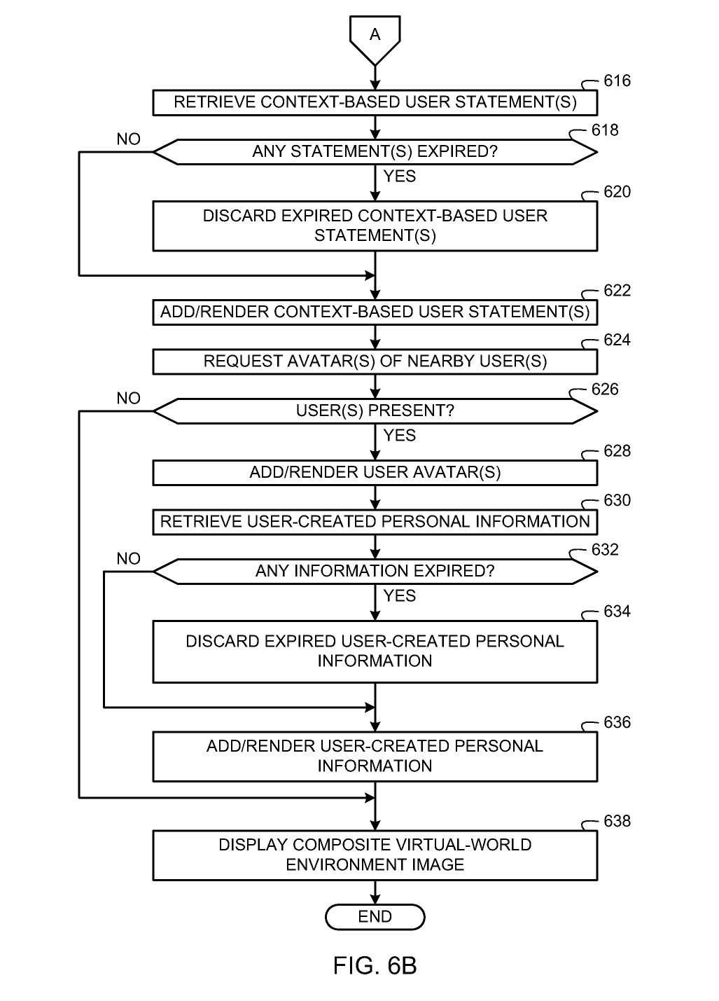

FIGS. 6A and 6B depict example flow diagrams representative of processes that may be implemented using, for example, computer readable instructions stored on a computer-readable medium to implement the example apparatus 400 of FIG. 4 to generate the example composite virtual-world environment image 202 of FIGS. 2 and 3. Although the example process of FIGS. 6A and 6B is described as being performed by the example apparatus 400 as implemented as part of the mobile device 106, some or all of the operations of the example process may additionally or alternatively be performed by a network entity such as, for example, any one or more of the servers 108, 110, and/or 112 of FIG. 1 or any other processor system having capabilities and/or features similar or identical to the apparatus 400.

The example process of FIGS. 6A and 6B may be performed using one or more processors, controllers, and/or any other suitable processing devices. For example, the example process of FIGS. 6A and 6B may be implemented using coded instructions (e.g., computer readable instructions) stored on one or more tangible computer readable media such as flash memory, read-only memory (ROM), and/or random-access memory (RAM). As used herein, the term tangible computer readable medium is expressly defined to include any type of computer readable storage and to exclude propagating signals. Additionally or alternatively, the example process of FIGS. 6A and 6B may be implemented using coded instructions (e.g., computer readable instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process of FIGS. 6A and 6B may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process of FIGS. 6A and 6B may be implemented manually or as any combination(s) of any of the foregoing techniques, for example, any combination of firmware, software, discrete logic and/or hardware. Further, although the example process of FIGS. 6A and 6B are described with reference to the flow diagrams of FIGS. 6A and 6B, other methods of implementing the process of FIGS. 6A and 6B may be employed. For example, the order of execution of the blocks may be changed, and/or some of the blocks described may be changed, eliminated, sub-divided, or combined. Additionally, any or all of the example process of FIGS. 6A and 6B may be performed sequentially and/or in parallel by, for example, separate processing threads, processors, devices, discrete logic, circuits, etc.

Now turning in detail to FIGS. 6A and 6B, initially the real-world data interface 406 (FIG. 4) receives real-world data (block 602) (FIG. 6A). In the illustrated example, the real-world data is sensor data from sensors in the mobile device 106 and is indicative of location and viewing direction (e.g., point of view or perspective of the person 104 of FIG. 1) of the person 104 in, for example, the real-world environment 100 of FIG. 1 at a particular time. The context determiner 408 (FIG. 4) determines a location of the mobile device 106 (block 604) and a viewing direction of the person 104 (block 606). In some examples, the context determiner 408 may determine the location using sensor data from a location subsystem (e.g., a GPS receiver) of the mobile device 106 and determine the viewing direction using sensor data from a digital compass and/or accelerometer of the mobile device 106. In other examples, the operations of blocks 604 and 606 can be performed without requiring the use of a location subsystem (e.g., a GPS receiver) or a digital compass and/or accelerometer of the mobile device 106. In such other examples, the real-world data received at block 602 may be digital images captured using a camera of the mobile device 106, and the context determiner 408 may use the digital images to determine the location (at block 604) and viewing direction (at block 606) based on a view from the perspective of the mobile device 106 through its camera as represented by the captured digital images. In some such other examples, the apparatus 400 sends the digital images to the real-world data sever(s) 112, and the real-world data server(s) 112 compare(s) the digital images to other digital images stored therein that are captured by one or more of the stationary sensors 116. In this manner, when the real-world data server(s) 112 find a match, the real-world data server(s) 112 can send location and/or viewing direction information to the apparatus 400 based on the match.

The virtual-reality interface 410 retrieves virtual-reality data (e.g., virtual-world graphics, textures, lighting conditions, etc.) corresponding to the location and/or viewing direction determined at blocks 604 and 606 (block 608). In the illustrated example, the virtual-reality interface 410 retrieves the virtual-reality data 206 (FIG. 2) from one or more of the virtual-reality server(s) 110 (FIG. 1). That is, the virtual-reality interface 410 submits the location and/or viewing direction information to the one or more virtual-reality server(s) 110, and the one or more virtual-reality server(s) 110 retrieve(s) relevant virtual-reality graphics including graphics of buildings, structures, or features representative of real buildings, structures, or features in the real-world environment (e.g., the real-world environment 100 of FIG. 1) at or near the provided location. In some examples, selection of some or all of the virtual-reality data 206 (e.g., virtual-reality graphics, textures, features, etc.) returned by the virtual-reality server(s) 110 may also be based on real-world data collected by the stationary sensors 116 of FIG. 1 and stored in the real-world data server(s) 112. For example, if the real-world data is indicative of rainy/overcast conditions, the virtual-reality data 206 may be darker-shade graphics and/or may include rain, lighted street lamps, wet pavements and/or other features characteristic of the rainy/overcast conditions. For instances in which high pedestrian traffic is detected, the virtual-reality data 202 can include graphics representative of numerous people. Any other types of graphics or texture effects can be received from the virtual-reality server(s) 110 at block 608 based on real-world data stored in the real-world data server(s) 112.

The processor 402 determines whether a user-specified theme has been specified (block 610). For example, a user-specified theme (e.g., a medieval theme) may be indicated by the person 104 (FIG. 1) via the user interface 404. If a user-specified theme has not been specified (block 610), control advances to block 614. If a user-specified theme has been specified (block 610), the virtual-reality interface 410 retrieves the user-specified modifications of virtual-world graphics 208 (FIG. 2) (block 612). In the illustrated example, the virtual-reality interface 410 submits a request to the virtual-reality server(s) 110 along with one or more identifiers identifying the user-specified modifications. After retrieving the user-specified modifications of virtual-world graphics 208 at block 612, the image generator 414 generates the composite virtual-world environment image 202 (FIGS. 2 and 3) (block 614) and control advances to block 616 of FIG. 6B.

The user-created information interface 412 (FIG. 4) retrieves one or more context-based user statement(s) (block 616) such as, for example, the user-created opinion 310 and/or the temporally-conditional user-created statement 312 of FIG. 3. For example, the user-created information interface 412 can submit the location information and/or viewing direction information determined at blocks 604 and 606 of FIG. 6A to one or more of the user-created information server(s) 108, and the user-created information server(s) 108 can use such information to retrieve and return context-based user statements to the user-created information interface 412. Such context-based user statements may be the temporally-conditional user-created statement 312 of FIG. 3 and/or any other user-created statement(s) that is/are contextually relevant to the determined location and/or viewing direction information.

The processor 402 determines whether any of the context-based user statement(s) retrieved at block 616 are expired (i.e., are no longer temporally relevant) (block 618). For example, the temporally-conditional user-created statement 312 of FIG. 3 may be stored in association with an expiration tag indicating that the statement 312 is only relevant for display on the date on which it was posted. An example expiration tag may include a date/time stamp indicative of the last date/time during which the statement 312 may be displayed. In the illustrated example, the temporal relevancy of the temporally-conditional user-created statement 312 is based on the statement 312 being descriptive of a condition of a restaurant on a particular date. If the processor 402 determines at block 618 that any of the context-based user statement(s) retrieved at block 616 are expired (i.e., are no longer temporally relevant), the processor 402 discards the expired context-based user statement(s) (block 620).

After discarding the expired context-based user statement(s) at block 620 or if the processor 402 determines at block 618 that none of the context-based user statement(s) retrieved at block 616 are expired (i.e., the statement(s) is/are temporally relevant), the image generator 414 adds or renders the temporally-relevant context-based user statement(s) (e.g., the temporally-conditional user-created statement 312) to the composite virtual-world environment image 202 (block 622).

The virtual-reality interface 410 requests one or more avatar(s) of any nearby user(s) (block 624). In the illustrated example, the virtual-reality interface 410 sends an avatar request to one or more of the user-created information server(s) 108 and/or one or more of the virtual-reality server(s) 110 along with the location and/or viewing direction information determined at blocks 604 and 606, and the user-created information server(s) 108 and/or the virtual-reality server(s) 110 retrieve and return relevant virtual-reality graphics of avatars (e.g., the avatars 302 and 304 of FIG. 3) representative of persons located in the real-world environment 100 at or near the provided location. The processor 402 then determines if nearby user(s) is/are present (block 626) based on, for example, whether the server(s) 108 and/or 110 returned any avatar(s). If the processor 402 determines at block 626 that nearby users are not present, the example process of FIG. 6B ends. If any user(s) is/are present (block 626), the image generator 414 adds or renders the received avatar(s) (e.g., one or both of the avatars 302 and 304 of FIG. 3) (block 628).

The user-created information interface 412 (FIG. 4) retrieves user-created personal information (block 630) such as, for example, the user-created personal information 314 and 316 of FIG. 3. For example, the user-created information interface 412 can submit the usernames and/or user identifiers of the avatar(s) identified at block 626 to one or more of the user-created information server(s) 108, and the user-created information server(s) 108 can use such usernames and/or user identifiers to retrieve and return user-created personal information (e.g., the user-created personal information 314 and 316) to the user-created information interface 412. In some examples, such user-created personal information may be temporally-conditional. In such some examples, the processor 402 determines whether any of the user-created personal information retrieved at block 630 is/are expired (i.e., is/are no longer temporally relevant) (block 632). For example, the user-created personal information may be stored in association with an expiration tag indicating that the information is only relevant for display on the date on which it was posted or up until a particular date. An example expiration tag may include a date/time stamp indicative of the last date/time during which the user-created personal information may be displayed. If the processor 402 determines at block 632 that any of the user-created personal information retrieved at block 630 is/are expired (i.e., is/are no longer temporally relevant), the processor 402 discards the expired user-created personal information (block 634).

After discarding the expired user-created personal information at block 634 or if the processor 402 determines at block 632 that none of the user-created personal information retrieved at block 630 is/are expired (i.e., the information is/are temporally relevant), the image generator 414 adds or renders the relevant user-created personal information (e.g., the user-created personal information 314 and 316) to the composite virtual-world environment image 202 (block 636). After the image generator 414 adds or renders the relevant user-created personal information to the composite virtual-world environment image 202 at block 636, the display interface 416 displays the composite virtual-world environment image 202 (block 638) via, for example, the display 510 of FIG. 5. The example process of FIGS. 6A and 6B ends.

Although not shown, the example process of FIGS. 6A and 6B may be repeated one or more times until the person 104 shuts down or ends an application rendering the composite virtual-world environment image 202 on the mobile device 106. That is, the content of the composite virtual-world environment image 202 can continually change as the person 104 and, thus, the mobile device 106, move through the real-world environment 100. In some examples, the content of the composite virtual-world environment image 202 can change fluidly in all directions to mimic or imitate the movements of the real point of view of the person 104 in the real-world environment 100. For example, while the person 104 is facing north in the real-world environment 100, the content of the composite virtual-world environment image 202 is updated or rendered to show virtual-world representations of real-world structures and/or features/characteristics perceivable by the person 104 when facing north in the real-world environment. If the person 104 turns to face south in the real-world environment, the content of the composite virtual-world environment image 202 is updated or rendered to show virtual-world representations of real-world structures and/or features/characteristics perceivable by the person 104 when facing south in the real-world environment.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method comprising:
receiving real-world data associated with a real-world environment in which a person is located at a particular time;
receiving virtual-reality data representative of a virtual-world environment corresponding to the real-world environment in which the person was located at the particular time;
displaying the virtual-world environment based on the virtual-reality data; and
displaying, in connection with the virtual-world environment, a supplemental visualization based on supplemental user-created information, the supplemental user-created information obtained based on the real-world data.

2. A method as defined in claim 1, wherein the supplemental user-created information is at least one of a user opinion associated with an establishment located in the real-world environment or a user statement associated with a characteristic of the real-world environment.

3. A method as defined in claim 1, further comprising modifying a virtual-reality entity corresponding to a real entity located in the real-world environment based on a user-specified modification of the virtual-reality entity.

4. A method as defined in claim 1, wherein the supplemental visualization is associated with a time expiration, the supplemental visualization being displayed when the time expiration has not expired.

5. A method as defined in claim 1, wherein the real-world data is sensor data generated by at least one of a location detector, a motion sensor, a compass, or a camera located in a mobile device to be worn or carried by the person.

6. A method as defined in claim 1, wherein the real-world data is sensor data generated by at least one stationary sensor fixedly located in the real-world environment in which the person is located.

7. A method as defined in claim 1, wherein the virtual-world environment and the supplemental visualization are displayed via a mobile device to be worn or carried by the person.

8. A method as defined in claim 1, wherein a server in a network combines the virtual-world environment with the supplemental visualization prior to the displaying of the virtual-world environment and the supplemental visualization via the mobile device.

9. A method as defined in claim 1, wherein the supplemental visualization is retrieved from at least one of a social networking server or a user-collaborative repository server.

10. A method as defined in claim 1, wherein the receiving of the real-world data and the receiving of the virtual-reality data are performed by an application executed by a mobile device to be worn or carried by the person.

11. An apparatus comprising:
a processor; and
a memory in communication with the processor and having instructions stored thereon that, when executed, cause the processor to:
receive real-world data associated with a real environment in which a person is located at a particular time;
receive virtual-reality data representative of a virtual-world environment corresponding to the real environment in which the person was located at the particular time;
display the virtual-world environment based on the virtual-reality data; and
display, in connection with the virtual-world environment, a supplemental visualization based on supplemental user-created information, the supplemental user-created information obtained based on the real-world data.

12. An apparatus as defined in claim 11, wherein the supplemental user-created information is at least one of a user opinion associated with an establishment located in the real environment, a user statement associated with a characteristic of the real environment, or a user-specified modification of a virtual-reality entity corresponding to a real entity located in the real environment.

13. An apparatus as defined in claim 11, wherein the instructions, when executed, further cause the processor to display the supplemental visualization when a time expiration associated with the supplemental visualization has not expired.

14. An apparatus as defined in claim 11, wherein the instructions, when executed, further cause the processor to receive the real-world data from at least one of a location detector, a motion sensor, a compass, or a camera located in a mobile communication device to be worn or carried by the person.

15. An apparatus as defined in claim 11, wherein the instructions, when executed, further cause the processor to receive the real-world data from at least one stationary sensor located in the real environment in which the person is located.

16. An apparatus as defined in claim 11, wherein the processor and the memory are located in a mobile communication device.

17. An apparatus as defined in claim 11, wherein the instructions, when executed, further cause the processor to receive the virtual-world environment and the supplemental visualization from a server in a network that combines the virtual-world environment with the supplemental visualization prior to the displaying of the virtual-world environment and the supplemental visualization.

18. An apparatus comprising:
a real-world data interface to receive real-world data associated with a real environment in which a person is located at a particular time;
a virtual-reality interface to receive virtual-reality data representative of a virtual-world environment corresponding to the real environment in which the person was located at the particular time; and
a display to display the virtual-world environment and at least one of a user opinion associated with an establishment located in the real-world environment or a user statement associated with a characteristic of the real-world environment.

19. An apparatus as defined in claim 18, wherein the at least one of the user opinion or the user statement is associated with a time expiration, the at least one of the user opinion or the user statement not being displayable after the time expiration has expired.

20. An apparatus as defined in claim 18, wherein the real-world data is sensor data generated by at least one stationary sensor fixedly located in the real-world environment in which the person is located, the real-world data interface to retrieve the real-world data from a server, the server to collect the real-world data from the at least one stationary sensor.
